(19) United States
(12) Patent Application Publication
(10) Pub. No.: US 2008/0145017 A1
(43) Pub. Date: Jun. 19, 2008

(54) AUDIO VISUAL DATA RECORDING/REPRODUCING DEVICE

(76) Inventors: Eiji MIYAGOSHI, Osaka (JP); Akihiro Watabe, Nara (JP)

Correspondence Address: MCDERMOTT WILL & EMERY LLP, 600 13TH STREET, NW, WASHINGTON, DC, 20005-3096, US

(21) Appl. No.: 11/951,567

(22) Filed: Dec. 6, 2007

(30) Foreign Application Priority Data
Dec. 14, 2006 (JP) 2006-337264

(51) Int. Cl. H04N 5/91

(52) U.S. Cl. 386/46

(57) ABSTRACT

An audio visual data recording/reproducing device, including: a fixed recording media recording/reproducing section for recording/reproducing audio visual data to/from a fixed recording medium provided fixedly; an external recording media recording/reproducing section for recording/reproducing audio visual data to/from a removable external recording medium; a control information reading section for reading out, from the external recording medium, control information regarding at least one of a method for recording audio visual data to the external recording medium and a method for reproducing audio visual data from the external recording medium; and a control section for controlling, based on the control information, at least one of an operation of recording audio visual data to the external recording medium and an operation of reproducing audio visual data from the external recording medium. Thus, when an external recording medium is loaded, the control information is read out, whereby at least one of the operation of recording audio visual data to the external recording medium and the operation of reproducing audio visual data from the external recording medium is controlled.

### BACKGROUND OF THE INVENTION

1. Field of the Invention

The present invention relates to an audio visual data recording/reproducing device, such as a so-called “hybrid-type image recording device”, including a DVD (Digital Versatile Disc) drive and a hard disk drive, for example.

2. Description of the Background Art

In recent years, the capacity of a hard disk drive and that of a removable medium such as a DVD or an SD card (semiconductor memory card) have increased so much that a single piece of such a medium can store an entire three-month run of a TV series, for example. When such a large quantity of audio visual data can be stored, an increasing amount of time and effort is required for rearranging the stored content, e.g., for copying and moving content items between different media. In view of this, a technique has been proposed in the art (for example, Japanese Laid-Open Patent Publication No. 2006-127599), in which when copying a portion of stream data stored on a DV (Digital Video) tape onto a DVD, for example, the portion of stream data to be copied is selected based on a keyword input by the user, thereby improving the operability.

With such a device, however, the user needs to input a keyword each time stream data is copied or moved, thus requiring a troublesome operation by the user.

### SUMMARY OF THE INVENTION

The present invention has been made in view of the above, and has an object to improve the operability when, for example, copying or moving audio visual data between recording media.

In order to achieve the object set forth above, an example of an audio visual data recording/reproducing device of the present invention includes:

a fixed recording media recording/reproducing section for recording/reproducing audio visual data to/from a fixed recording medium provided fixedly;

an external recording media recording/reproducing section for recording/reproducing audio visual data to/from a removable external recording medium;

a control information reading section for reading out, from the external recording medium, control information regarding at least one of a method for recording audio visual data to the external recording medium and a method for reproducing audio visual data from the external recording medium; and

a control section for controlling, based on the control information, at least one of an operation of recording audio visual data to the external recording medium and an operation of reproducing audio visual data from the external recording medium.

Thus, when an external recording medium is loaded, the control information is read out, whereby at least one of the operation of recording audio visual data to the external recording medium and the operation of reproducing audio visual data from the external recording medium is controlled.

### BRIEF DESCRIPTION OF THE DRAWINGS

FIG. 1 is a block diagram showing a configuration of an audio visual data recording/reproducing device of Embodiment 1.

FIG. 2 is a flow chart showing an operation of the device when loading a DVD.

FIG. 3 is a flow chart showing an operation of the device for writing a search keyword when copying AV data.

FIG. 4 is a block diagram showing a configuration of an audio visual data recording/reproducing device of Embodiment 2.

FIG. 5 is a flow chart showing an operation of the device when copying broadcast AV data.

FIG. 6 is a block diagram showing a configuration of an audio visual data recording/reproducing device of Embodiment 3.

FIG. 7 is a flow chart showing an operation of the device when reproducing AV data.

FIG. 8 is a block diagram showing a configuration of an audio visual data recording/reproducing device of Embodiment 4.

FIG. 9 is a flow chart showing an operation of the device for writing a search keyword when manually copying AV data.

### DETAILED DESCRIPTION OF THE PREFERRED EMBODIMENTS

Embodiments of the present invention will now be described in detail with reference to the drawings. In each of the following embodiments, like elements to those of preceding embodiments are denoted by like reference numerals and will not be described repeatedly.

### Embodiment 1

(Configuration of DVD Recorder)

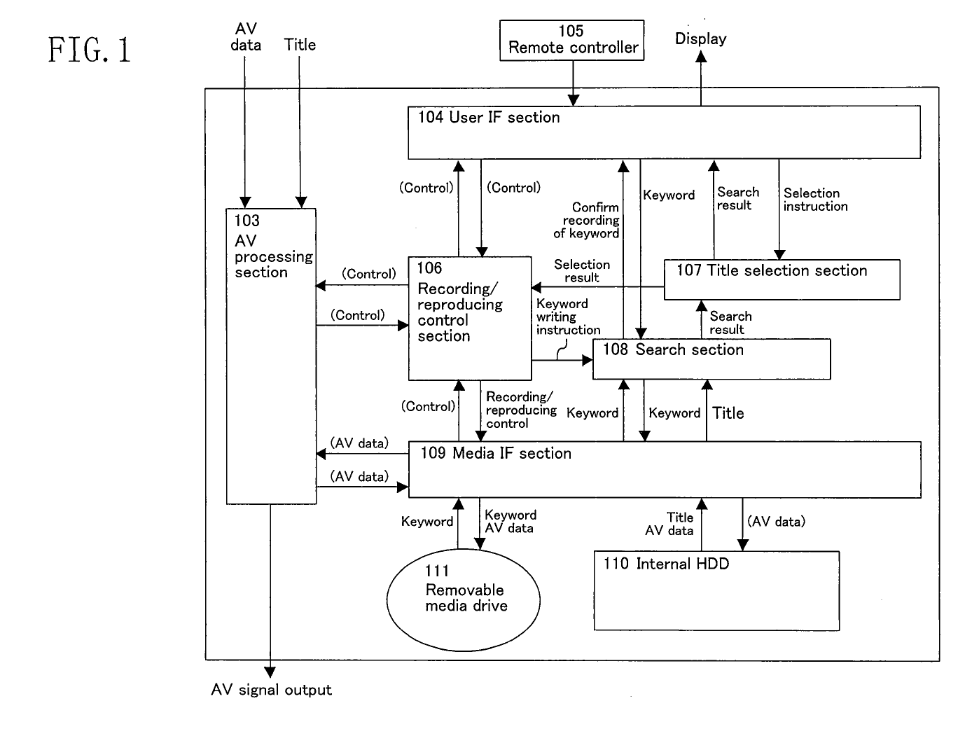

An audio visual data recording/reproducing device of Embodiment 1 is a DVD recorder including a hard disk drive (HDD) therein. The DVD recorder has a configuration as shown in FIG. 1, for example.

An internal HDD 110 stores audio visual (AV) data.

A removable media drive 111 records/reproduces AV data to/from a removable medium such as a DVD or a semiconductor memory card.

A media IF section 109 interfaces various sections inside the device with the internal HDD 110 and the removable media drive 111.

An AV processing section 103 receives AV data, which is sent via a broadcast network or other communications networks, to convert the AV data to a format that can be recorded on the internal HDD 110 or the removable media drive 111, or decodes such AV data to produce and output an AV signal to a display device (not shown). The AV processing section 103 also receives electronic program guide information, called “EPG”, for example, including titles, keywords, cast information, etc., of programs. For the purpose of illustration, this information is assumed to be primarily titles of AV data in the following description.

An user IF section 104 interfaces the user with the device. More specifically, the user IF section 104 communicates with a remote controller 105 to accept a user operation, or displays various information on a display device (not shown).

A search section 108 searches through AV data recorded on the internal HDD 110 for those whose titles contain the search keyword, in a case where a search keyword (control information) is written on a DVD.

A title selection section 107 accepts a user selection while displaying a title or titles obtained as a result of the search on a display section.

A recording/reproducing control section 106 controls a recording/reproducing operation, etc., according to a user operation, and controls the operation of the AV processing section 103, moving or copying (dubbing) AV data between the internal HDD 110 and the removable media drive 111, etc., based on the user selection.

(Operation of Recording/Reproducing Device)

In a recording/reproducing device having such a configuration, AV data recorded on the internal HDD 110 is copied onto a DVD as follows.

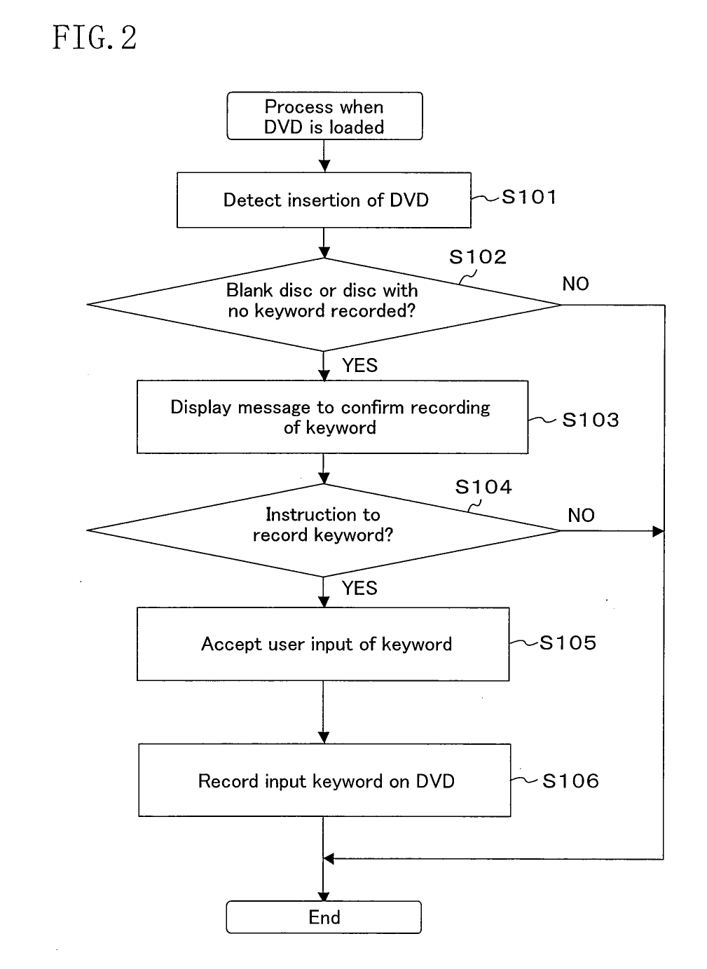

First, when a DVD is loaded, a process as shown in FIG. 2 is performed.

(S101) The media IF section 109 detects that a DVD is loaded.

(S102) The search section 108 determines whether a search keyword is written on the loaded DVD. If not (e.g., a blank disc), S103 and subsequent steps are performed.

(S103) The search section 108 displays a message via the user IF section 104, indicating that no search keyword is written on the loaded DVD or that the loaded DVD is a blank disc, prompting the user to decide whether or not to write a search keyword.

(S104) The search section 108 determines whether the user has instructed to write a search keyword.

(S105) When instructed to write a search keyword, the user IF section 104 further accepts a user input of a search keyword.

(S106) The search section 108 writes the input search keyword on the DVD via the media IF section 109.

If the loaded DVD is a blank disc, the DVD may be formatted as necessary, where the search keyword is written thereon (or where the search keyword is not written thereon).

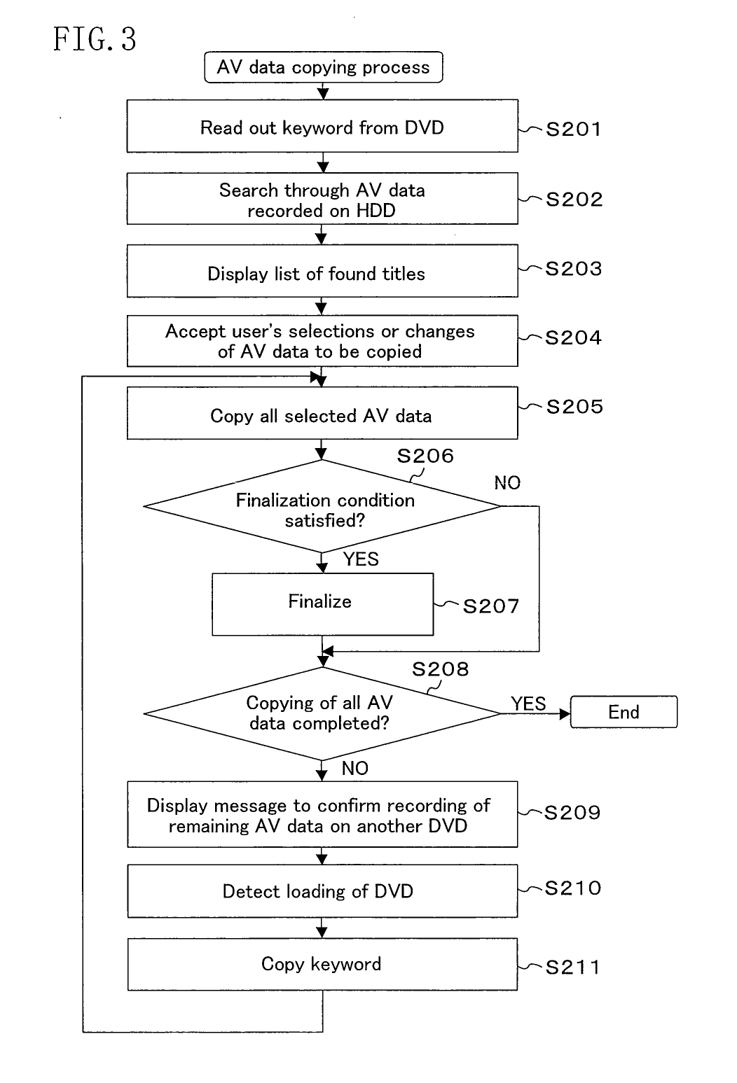

If a search keyword is written on the DVD in S106 as described above or if it is determined in S102 that a search keyword has already been written thereon, a process as shown in FIG. 3 is performed to copy the AV data recorded on the internal HDD 110 to the DVD.

(S201) The search section 108 reads out the search keyword from the DVD via the media IF section 109.

(S202) Then, the search section 108 searches through the AV data recorded on the internal HDD 110 for those whose titles contain the search keyword.

(S203) The title selection section 107 displays found titles via the user IF section 104.

(S204) The title selection section 107 further accepts user's selections or changes of selection of AV data to be copied, from among the search results. Copying may start automatically without accepting such user inputs. Control information indicating whether or not copying should start automatically may be recorded on the DVD in advance.

(S205) The recording/reproducing control section 106 successively reads out the selected AV data (including the titles thereof), which are equal to the search results if the user makes no changes thereto, from the internal HDD 110 and records the AV data on the DVD, thus copying the AV data.

(S206, S207) The recording/reproducing control section 106 determines whether a predetermined finalization condition is satisfied. If so, the disc is finalized to prevent, for example, data from being added to or deleted from the disc. Examples of the finalization condition include, for example: when the DVD becomes full (more specifically, when the ratio between the remaining capacity of the DVD and the average file size of AV data that have been copied thereto (“the estimated file size”) becomes less than or equal to a predetermined value); and when the title, or the like, of the copied AV data indicates that the copied AV data is the last episode of a TV series. Whether or not to finalize the disc, and conditions for making such a decision, may also be recorded on the DVD as control information. Then, a disc can be finalized with no user intervention. The user may be prompted to finally decide whether or not to permit the finalization process.

(S208) The copying process is complete when all the selected pieces of AV data have been copied. At this point, the user may be allowed to check the finalization conditions of S206 and S207 as described above. If all the selected pieces of AV data did not fit on the loaded DVD, the process proceeds to S209.

(S209) The recording/reproducing control section 106 displays a message, via the user IF section 104, prompting the user to decide whether or not to record the remaining pieces of AV data on another DVD.

(S210) The media IF section 109 detects the loading of the next DVD.

(S211) The recording/reproducing control section 106 instructs the search section 108 to record the search keyword, which was recorded on the first DVD, also on this newly-loaded DVD. Then, S205 and subsequent steps are repeated (the process may return further back to S203, thereby repeating the confirmation of AV data to be copied). As the search keyword is recorded on the next DVD as described above, AV data of the same kind can be automatically searched and copied also on the DVD. If another search keyword has already been recorded on the newly-loaded DVD, for example, the existing search keyword may be replaced by the current search keyword or the current search keyword may be written in addition to the existing search keyword. Alternatively, the system may accept only a blank disc or a DVD with no search keyword recorded thereon. Information identifying the disc number in the series of discs may be automatically written on each disc.

In the example above, a search keyword specified by the user is recorded on a DVD, but the present invention is not limited to this. For example, a search keyword or search keywords, which have been provided via a broadcast network or other communications networks (for fee or free of charge), may be recorded on the DVD. Moreover, DVDs with search keywords written thereon in advance by broadcasting stations or by sponsors may be circulated (a content provider, such as a broadcasting station, can easily provide search information of higher search precisions).

In the example above, a search keyword is recorded on a DVD, but the present invention is not limited to this. For example, the (lowest) level of image quality at which the AV data has been recorded may be recorded and used instead of a search keyword.

Moreover, the user may be allowed to edit such control information to be recorded on a DVD or control information already recorded on a DVD.

Although the example above is directed to a copy operation, the present invention is not limited to this, and a move operation (recording data on a DVD and deleting the data from the internal HDD 110) may be performed. In such a case, whether to copy or move the AV data may be determined by a user instruction, based on the control information recorded on the DVD, or automatically. The user may be prompted to either confirm or change the type of operation, wherein what is indicated by the control information recorded on the DVD is shown as a default.

When recording AV data on a DVD, the AV data may be subjected to a process such as image quality conversion (recompression), depending on the remaining capacity of the DVD. In such a case, control information indicating the lowest acceptable level of image quality, and the like, may be recorded on the DVD and used for controlling the image quality conversion or controlling the copy canceling process. Where AV data can be recorded if the image quality thereof is converted, the user may be prompted to confirm the conversion. Even when the instruction is to move AV data, the operation may be automatically changed to a copy operation if the recording will degrade the image quality of the AV data and if such a change is acceptable.

As necessary, the system may record, on the internal HDD 110, information indicating that a piece of AV data has been copied, information identifying the DVD on which the AV data has been copied, and information indicating any processes, such as image quality conversion, that have been done before recording the AV data on the DVD. Thus, it is possible to easily prevent a piece of AV data from being copied repeatedly on other DVDs, and to ensure that only a copy operation with a better image quality is performed for the same piece of AV data (such information indicating that a piece of AV data has been copied may be presented to the user based on which the user can select pieces of AV data to be deleted when the internal HDD 110 is becoming full, or may be used to determine the order of priority in which pieces of AV data are allowed to be deleted).

When displaying a list of pieces of AV data to be recorded on DVDs, the system may display only a subset of pieces of AV data that can be recorded on the loaded DVD (with or without image quality conversion).

Although the example above is directed to a case where AV data are searched by the title, the present invention is not limited to this, and AV data may be searched by any other various information that are associated with or contained in the AV data, e.g., program descriptions, genres, keywords, cast, etc. Then, a set of pieces of AV data, which are programs of a TV series, programs related to one another, or programs sharing the same person included in the cast, for example, may be recorded simply by loading a DVD. Thus, AV data can be easily rearranged or managed.

### Embodiment 2

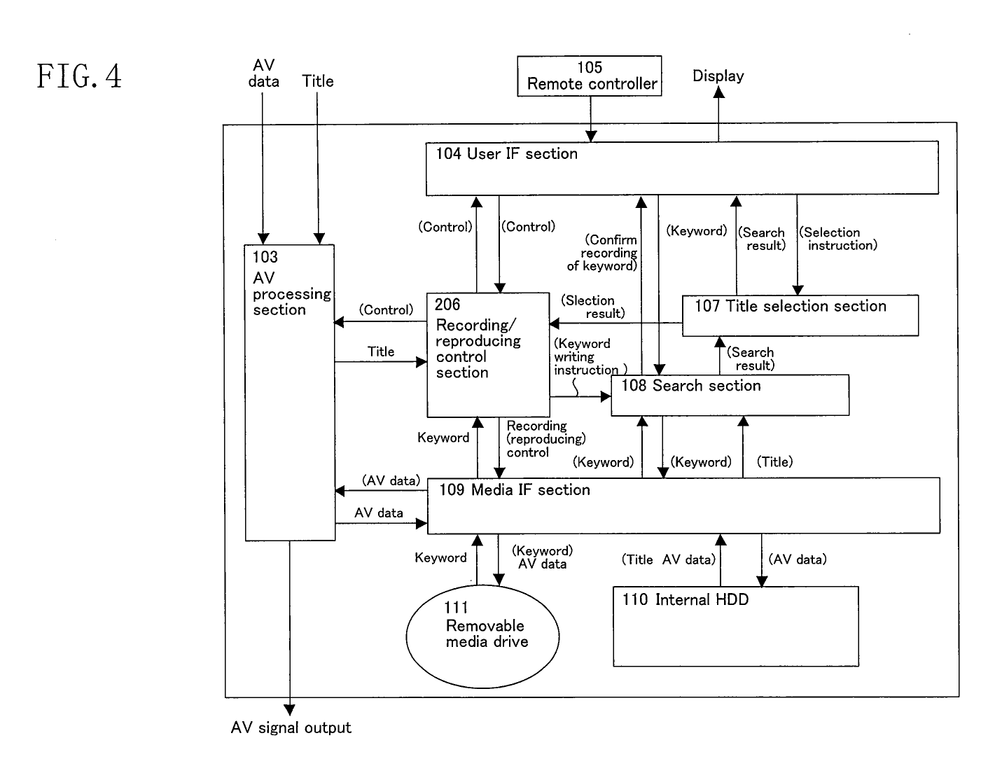

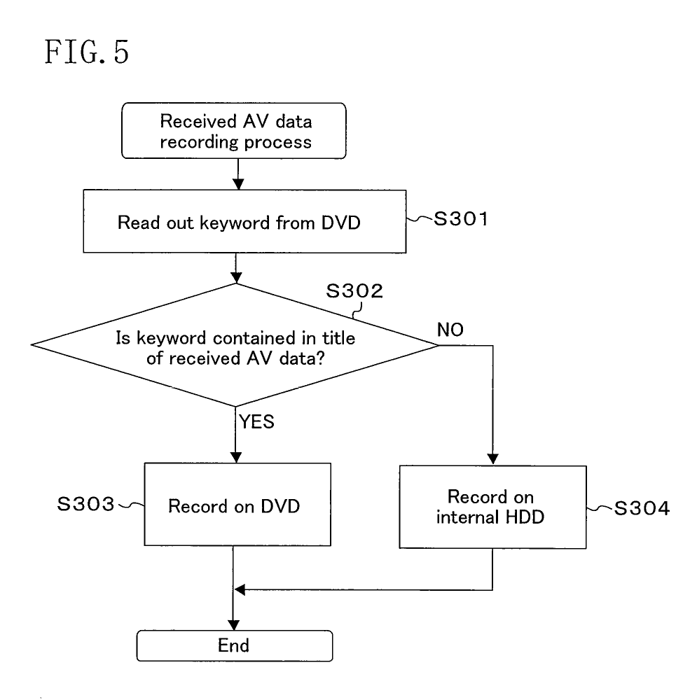

Embodiment 2 is directed to an example of an audio visual data recording/reproducing device, which controls the recording medium on which AV data received via a broadcast network or other communications networks is recorded based on the search keyword recorded on a DVD, or the like. Referring to FIG. 4, the audio visual data recording/reproducing device includes a recording/reproducing control section 206, instead of the recording/reproducing control section 106 of Embodiment 1. The recording/reproducing control section 206 performs a process as shown in FIG. 5, in addition to a process similar to that of the recording/reproducing control section 106.

(S301) When a DVD is loaded, the recording/reproducing control section 206 reads out a search keyword recorded on the DVD. When no DVD is loaded, the received AV data is recorded on the internal HDD 110 as with an ordinary recording/reproducing device.

(S302) The recording/reproducing control section 206 determines whether the title of the received AV data contains the search keyword. The process proceeds to S303 if the search keyword is contained, and to S304 otherwise.

(S303) The recording/reproducing control section 206 records the received AV data on the DVD.

(S304) The recording/reproducing control section 206 records the received AV data on the internal HDD 110.

As described above, the received AV data can be recorded on a DVD if the loaded DVD has a search keyword recorded thereon, whereby the same DVD as that obtained by copying AV data with the device of Embodiment 1 can be obtained upon receiving the AV data.

The present invention is not limited to a case where AV data is recorded either on the DVD or on the internal HDD 110. For example, AV data that is recorded on a DVD may also be recorded on the internal HDD 110 simultaneously.

The present invention is not limited to a case where every piece of AV data received is recorded either on a DVD or on the internal HDD 110. For example, such a control may be applied only to those that match predetermined recording conditions, e.g., keywords or genres determined by the user in advance, and to those that have been programmed to be recorded. Even a piece of AV data that does not match the recording conditions may be recorded on a DVD if the AV data contains the search keyword recorded on the DVD.

If a DVD with no search keyword written thereon is loaded and if a writing process as shown in FIG. 2 is not performed, determination as described above is not made. In such a case, all pieces of AV data received can be recorded on a DVD or on the internal HDD 110 as selected by the user as long as the storage capacity permits such recording. If no search keyword is recorded on a DVD and if AV data matching the recording conditions as described above is received, the AV data may be recorded preferentially or always on the internal HDD 110.

### Embodiment 3

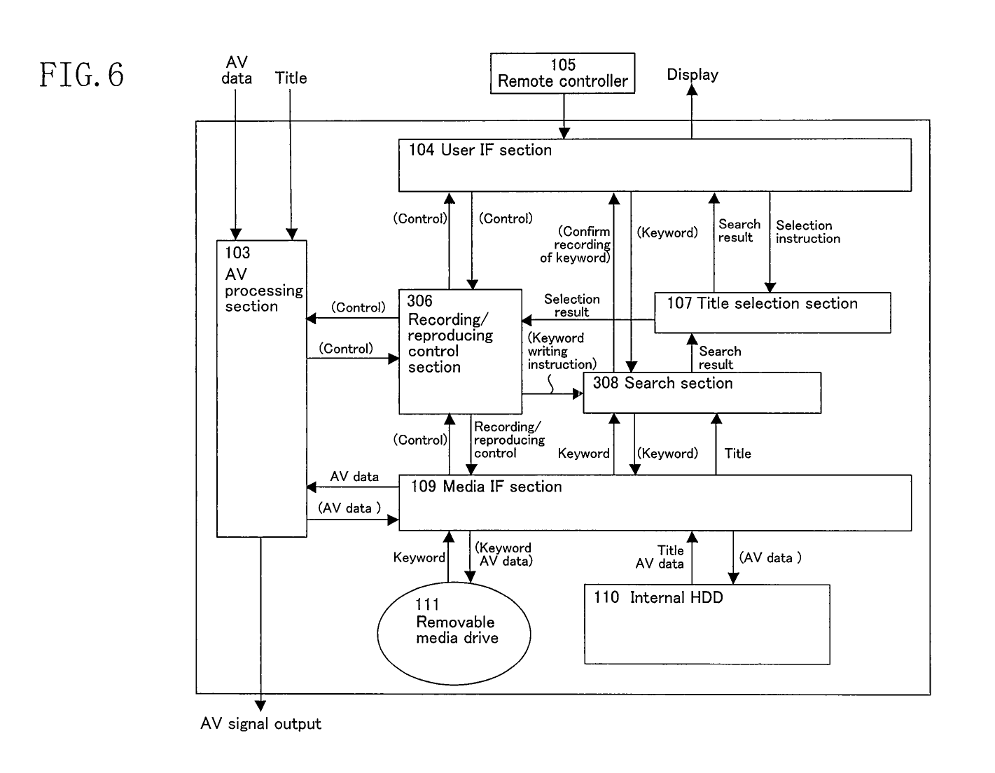

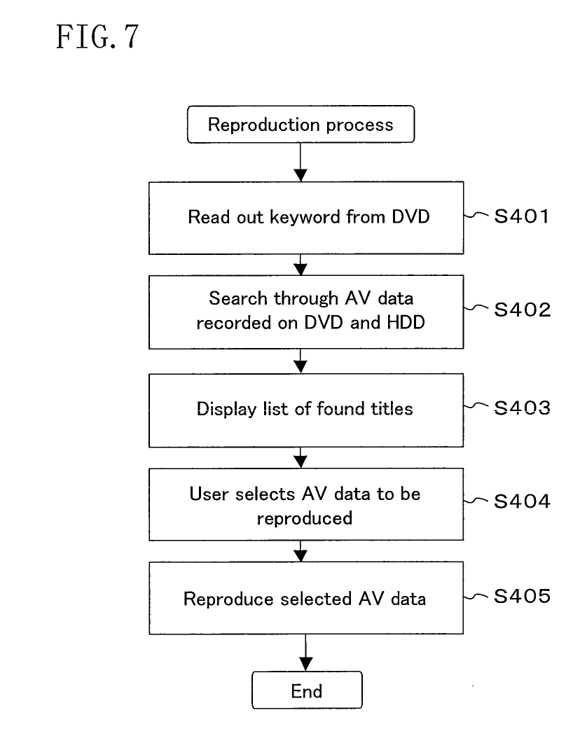

Embodiment 3 is directed to an audio visual data recording/reproducing device, which uses the search keyword recorded on the DVD, etc., when the user selects pieces of AV data to be reproduced. Referring to FIG. 6, the audio visual data recording/reproducing device includes a recording/reproducing control section 306 and a search section 308, instead of the recording/reproducing control section 106 and the search section 108 of Embodiment 1. The recording/reproducing control section 306, etc., perform a process similar to that of the recording/reproducing control section 106, etc., and in addition perform a process as shown in FIG. 7.

(S401) When a DVD is loaded, the search section 308 reads out the search keyword recorded on the DVD.

(S402) Then, the search section 308 searches through AV data recorded on the DVD and the internal HDD 110 for those whose titles contain the search keyword. With the DVD, the titles of all the AV data recorded thereon may be obtained (the same results will be obtained if only the AV data that match the search keyword have been recorded as in Embodiments 1 and 2).

(S403) The title selection section 107 displays the titles of the AV data found as a result of the search. If the same piece of AV data is recorded both on the DVD and on the internal HDD 110, the title of one of them or the titles of both of them may be displayed. Particularly, where the two pieces are of the same content but with different image qualities, the system may display only the one with a higher image quality or may display the one with a higher image quality more preferentially (e.g., at an upper position where the AV data is more likely to be selected by the user).

(S404) The title selection section 107 further accepts a user's selection of AV data to be reproduced from among the search results.

(S405) The recording/reproducing control section 306 reproduces the selected AV data. Specifically, the AV data recorded on the DVD or the internal HDD 110 is read out and input to the AV processing section 103, which outputs the AV data as an AV signal.

As described above, where pieces of AV data according to a search keyword are recorded on a DVD as in Embodiments 1 and 2, the titles of other AV data of the same kind, which are recorded on the internal HDD 110, can also be displayed to the user, who can then easily select and reproduce pieces of AV data, which are programs of a TV series or programs related to one another, from a plurality of recording media.

### Embodiment 4

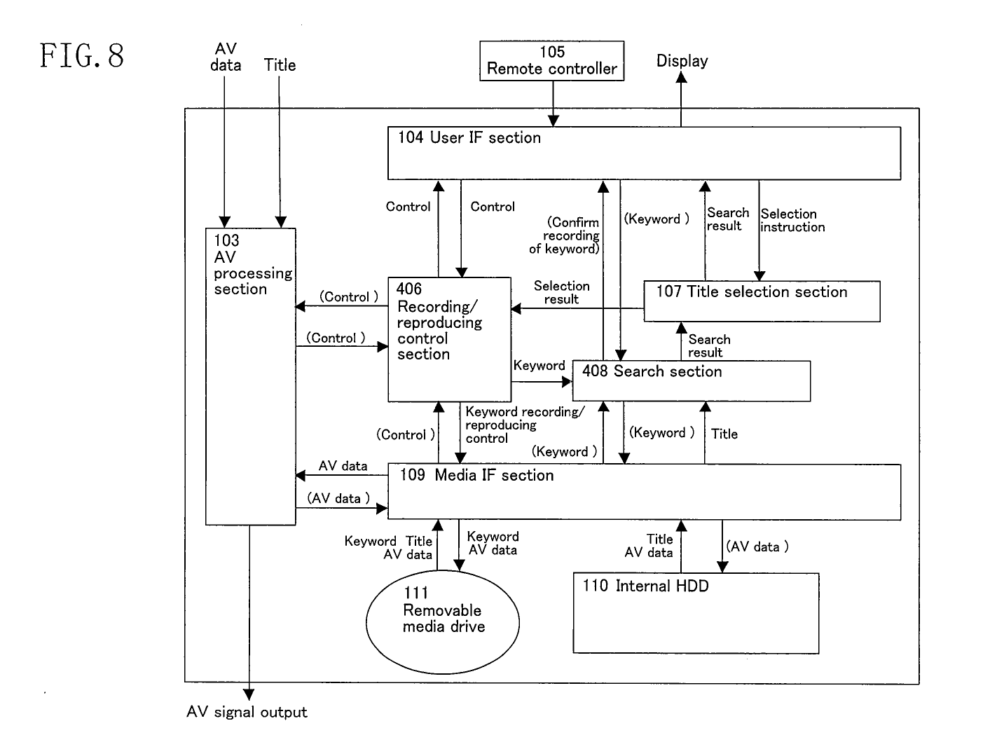

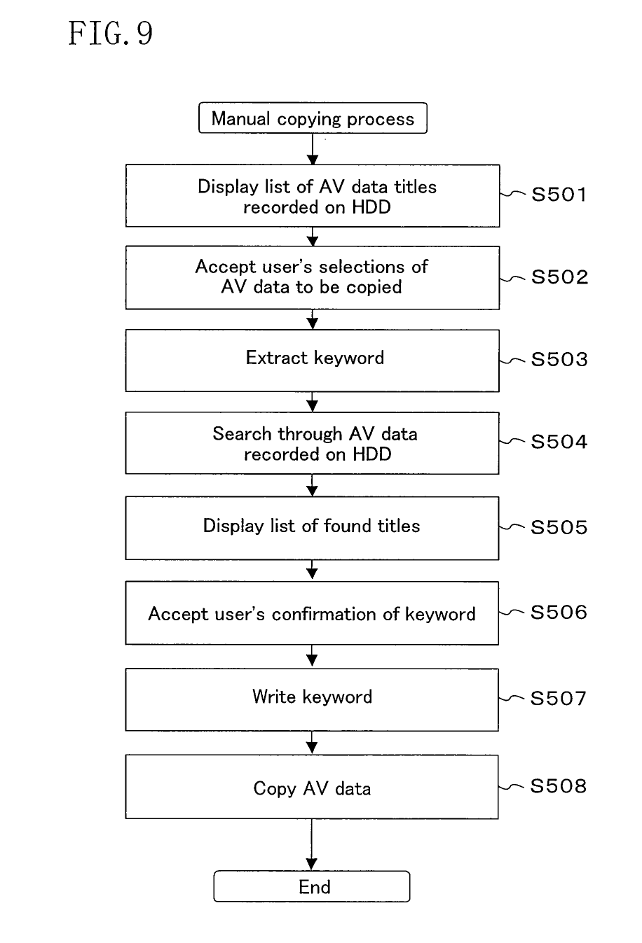

Embodiment 4 is directed to another example where a search keyword is recorded on a DVD. Referring to FIG. 8, the audio visual data recording/reproducing device includes a recording/reproducing control section 406 and a search section 408, instead of the recording/reproducing control section 106 and the search section 108 of Embodiment 1. The recording/reproducing control section 406, etc., perform a process similar to that of the recording/reproducing control section 106, etc., and in addition performs a process as shown in FIG. 9.

(S501) The search section 408 selects all pieces of AV data recorded on the internal HDD 110 as the search results, and the title selection section 107 displays the titles of the search results.

(S502) The title selection section 107 further accepts user's selections of AV data to be copied from among the displayed titles.

(S503) The recording/reproducing control section 406 extracts, as a search keyword, a keyword that is common among the selected titles (where only one piece of AV data is selected, the title of the piece of AV data may be used as the search keyword, for example).

(S504) The search section 408 searches through AV data recorded on the internal HDD 110 by using the extracted search keyword.

(S505) The title selection section 107 displays the titles of the found pieces of AV data along with the search keyword. A display process such as this and the following confirmation process in S506 do not have to be performed, and when the search section 408 searches the same piece of AV data as that selected by the user in S502, the search keyword may immediately be recorded on the DVD.

(S506) The recording/reproducing control section 406 accepts user's confirmation of the search keyword. Specifically, it is checked whether search results obtained by the current search keyword are as intended by the user. As necessary, the user may be allowed to, for example, change, add and delete search keywords.

(S507) The recording/reproducing control section 406 writes the search keyword confirmed by the user on the DVD.

(S508) The recording/reproducing control section 406 successively reads out the selected or found pieces of AV data from the internal HDD 110 and records them on the DVD, thus copying (or moving) the AV data. Alternatively, the system may only write the search keyword without copying AV data, or whether or not to copy AV data may be determined based on a user instruction. The process of extracting and recording search keywords as described above may be performed not only when copying AV data but also when a selection is made for reproducing AV data, for example.

As described above, appropriate search keywords can easily be recorded on the DVD merely by selecting pieces of AV data, which have already been recorded on the internal HDD 110.

Where AV data is recorded on a DVD and no search keyword is recorded thereon, search keywords may be extracted and recorded on the DVD based on the AV data recorded thereon.

Even if the operation of writing a search keyword is not performed, it is possible to easily select, reproduce and copy pieces of AV data, which are programs of a TV series or programs related to one another, for example, by extracting search keywords and performing searches based on the extracted search keywords as described above.

### Other Examples of Control Information

The control information recorded on a DVD, etc., may include those mentioned above (e.g., search keywords, information on whether or not to automatically start a copy operation when the DVD is loaded, information on the finalization process, information on whether AV data is to be copied or moved, information on the level of image quality), and other various control information that relate to at least one of a method for recording audio visual data on the DVD, etc., and a method for reproducing audio visual data from the DVD, etc.

For example, control information that enables identification of commercial messages (CMs) from non-CM portions of a broadcast program may be provided by a broadcasting station or a sponsor and recorded on a DVD so that CMs can be cut off when recording the program on the DVD or when reproducing the program, thus enhancing the value added to DVDs distributed by a broadcasting station, etc. Similarly, it is possible to use control information such that CMs are prevented from being cut off or skipped, and a recording medium with such control information recorded thereon can be used for advertising campaigns, or the like.

Moreover, various control information themselves may be encrypted or broadcast as undisclosed information, and a decryption key for decrypting the encrypted control information, or the like, may be recorded on a DVD as control information. This also enhances the value added to such DVDs to be distributed.

Alternatively, the system may use, for example, control information for displaying a selection menu used when AV data includes multiple stories, control information for enabling access to information on the Internet that is related to the recording or reproduction of the AV data, and control information that indicates the style of menu used for displaying a list of pieces of AV data recorded thereon.

The system may also use control information that enables the reproduction of a recording of free, broadcast AV data in a manner similar to that in which AV data recorded on a sold DVD is reproduced.

The system may record such control information on a DVD that a recording control similar to that with programmed recording is provided so that specified pieces of AV data are recorded automatically only by loading the DVD.

Moreover, the system may record, on a DVD, control information that can relax the ordinary copyright control by, for example, lifting the copy prevention control or increasing the maximum number of copies allowed to be made.

As described above, the audio visual data recording/reproducing device of the present invention can improve the operability when, for example, copying or moving audio visual data between recording media.

What is claimed is:

1. An audio visual data recording/reproducing device, comprising:
a fixed recording media recording/reproducing section for recording/reproducing audio visual data to/from a fixed recording medium provided fixedly;
an external recording media recording/reproducing section for recording/reproducing audio visual data to/from a removable external recording medium;
a control information reading section for reading out, from the external recording medium, control information regarding at least one of a method for recording audio visual data to the external recording medium and a method for reproducing audio visual data from the external recording medium; and
a control section for controlling, based on the control information, at least one of an operation of recording audio visual data to the external recording medium and an operation of reproducing audio visual data from the external recording medium.

2. The audio visual data recording/reproducing device of claim 1, wherein:
the control information includes selection information indicating a selection of at least one piece of audio visual data from among a plurality of pieces of audio visual data; and
the control section copies or moves the piece of audio visual data selected by the selection information from among the pieces of audio visual data stored in the fixed recording medium to the external recording medium.

3. The audio visual data recording/reproducing device of claim 2, wherein:
the selection information includes a search keyword; and
the control section selects a piece or pieces of audio visual data recorded on the fixed recording medium such that the search keyword is contained in the selected piece or pieces of audio visual data or attribute information thereof.

4. The audio visual data recording/reproducing device of claim 3, further comprising a search keyword writing section for writing a user-specified search keyword on the external recording medium.

5. The audio visual data recording/reproducing device of claim 3, further comprising:
a search keyword extraction section for extracting a search keyword from audio visual data already recorded on the external recording medium or from attribute information of the audio visual data; and
a search keyword writing section for writing the extracted search keyword on the external recording medium.

6. The audio visual data recording/reproducing device of claim 3, further comprising:
a search keyword extraction section for extracting a search keyword from a piece or pieces of audio visual data, or attribute information thereof, selected by a user from among pieces of audio visual data recorded on the fixed recording medium; and
a search keyword writing section for writing the extracted search keyword on the external recording medium.

7. The audio visual data recording/reproducing device of claim 6, further comprising an additional selection section for adding, to the selection by the user, a piece or pieces of audio visual data from among a plurality of pieces of audio visual data recorded on the fixed recording medium such that the extracted search keyword is contained in the added piece or pieces of audio visual data or attribute information thereof.

8. The audio visual data recording/reproducing device of claim 2, wherein if a piece of audio visual data received from outside while the external recording medium is loaded is a piece of audio visual data to be selected according to the selection information, the control section records the received piece of audio visual data on the external recording medium.

9. The audio visual data recording/reproducing device of claim 2, wherein the control section controls an image quality of a piece or pieces of audio visual data copied or moved from the fixed recording medium to the external recording medium according to a remaining capacity of the external recording medium, and the control section instructs a copy operation instead of a move operation if the image quality is to be degraded even if an operation of moving audio visual data is instructed by a user.

10. The audio visual data recording/reproducing device of claim 2, further comprising a selection information writing section, wherein where audio visual data in excess of a maximum capacity for which audio visual data can be copied or moved from the fixed recording medium to the external recording medium is recorded on another external recording medium, the selection information writing section writes the selection information also on the other external recording medium.

11. The audio visual data recording/reproducing device of claim 2, further comprising a finalization section for finalizing the external recording medium after completion of a copy or move operation from the fixed recording medium to the external recording medium, depending on at least one of a remaining capacity of the external recording medium and information on the copied or moved audio visual data.

12. The audio visual data recording/reproducing device of claim 11, wherein the finalization section finalizes the external recording medium if the copied or moved audio visual data is a last one of a series of programs.

13. The audio visual data recording/reproducing device of claim 11, wherein whether or not the finalization section finalizes the external recording medium is determined based on a size of the copied or moved audio visual data and the remaining capacity of the external recording medium.

14. The audio visual data recording/reproducing device of claim 13, wherein the finalization section estimates a size of audio visual data to be copied or moved based on the size of the copied or moved audio visual data, and whether or not the finalization section finalizes the external recording medium is determined based on the estimated size and the remaining capacity of the external recording medium.

15. The audio visual data recording/reproducing device of claim 2, wherein when the control section displays on a display section a list of pieces of audio visual data recorded on the external recording medium as a list of pieces of audio visual data that can be reproduced, the control section also displays a list of pieces of audio visual data that are selected according to the selection information among all pieces of audio visual data recorded on other recording media.

16. The audio visual data recording/reproducing device of claim 15, wherein where pieces of audio visual data of a same content but with different image qualities are recorded on the external recording medium and other recording media, the control section preferentially displays one of the pieces of audio visual data with a higher image quality.

17. The audio visual data recording/reproducing device of claim 2, wherein:
the control information further includes a menu display information indicating a style of menu used for displaying on a display section a list of pieces of audio visual data recorded on the external recording medium; and
the control section displays a list of pieces of audio visual data recorded on the external recording medium based on the menu display information.

18. The audio visual data recording/reproducing device of claim 1, wherein:
the control information includes lowest image quality information indicating a lowest image quality that should be ensured of audio visual data recorded on the external recording medium; and
the control section controls an image quality of audio visual data recorded on the external recording medium according to the lowest image quality information and a remaining capacity of the external recording medium.

19. The audio visual data recording/reproducing device of claim 18, wherein the control section records audio visual data with a lower image quality as the remaining capacity of the external recording medium is smaller, and cancels a recording operation if the remaining capacity is smaller than that which is needed for recording the audio visual data with the lowest image quality.

20. The audio visual data recording/reproducing device of claim 1, wherein:
the control information includes advertisement control information regarding recording or reproduction of advertisement audio visual data received from outside the device; and
the control section performs at least one of a process of preventing the advertisement audio visual data from being recorded, a process of forcibly recording the advertisement audio visual data, and a process of preventing reproduction of the advertisement audio visual data from being skipped.

21. An audio visual data recording/reproducing method, comprising:
a control information reading step of reading out from a removable external recording medium control information regarding at least one of a method for recording audio visual data on the external recording medium and a method for reproducing audio visual data from the external recording medium; and
a recording/reproducing step of controlling at least one of recording and reproduction of audio visual data to/from the external recording medium based on the control information.

22. The audio visual data recording/reproducing method of claim 21, wherein:
the control information includes selection information indicating a selection of at least one piece of audio visual data from among a plurality of pieces of audio visual data; and
the recording/reproducing step copies or moves, to the external recording medium, a piece or pieces of audio visual data selected by the selection information from among a plurality of pieces of audio visual data recorded on a fixed recording medium provided fixedly in an audio visual data recording/reproducing device.

23. A recording medium capable of being loaded on and removed from an audio visual data recording/reproducing device, wherein control information regarding at least one of a method for recording audio visual data on the recording medium and a method for reproducing audio visual data from the recording medium is recorded on the recording medium.

24. The recording medium of claim 23, wherein the control information includes selection information indicating a selection of at least one piece of audio visual data from among a plurality of pieces of audio visual data.

25. The recording medium of claim 23, wherein the control information includes lowest image quality information indicating a lowest image quality that should be ensured of audio visual data recorded on the recording medium.
